(19) United States
(12) Patent Application Publication
(10) Pub. No.: US 2024/0227317 A1
(43) Pub. Date: Jul. 11, 2024

(54) Automatic welding machine and method for thermal joining of material sheets

(71) Applicant: Leister Technologies AG, Kägiswil (CH)

(72) Inventors: Roger Bürgler, Ennetbürgen (CH); Paul Röthlin, Kerns (CH)

(21) Appl. No.: 18/408,341

(22) Filed: Jan. 9, 2024

(30) Foreign Application Priority Data
Jan. 9, 2023 (EP) 23 150 789.8

(51) Int. Cl. B29C 65/00; B29C 65/02

(52) U.S. Cl. CPC B29C 66/8145; B29C 65/02; B29C 66/1122

(57) ABSTRACT

An automatic welding machine for thermally joining sheets of material, in particular for edge side joining of an overlapping upper material sheet to a lower of material sheet, to be connected to one another in a materially bonded manner under the application of heat and subsequent application of pressure, is provided comprising: a heating device for at least partially heating the material sheets to be joined in a connection region; a support frame with a housing; a pressure roller; at least two traveling rollers; wherein the pressure roller and the traveling rollers are arranged on the support frame and together with the support frame form a chassis, wherein the chassis comprises a longitudinal axis and a transverse axis perpendicular thereto, which span a chassis plane; wherein at least a first travelling roller of the two travelling rollers and/or the heating device is arranged to be movable by a telescopic pull-out relative to the support frame in directions parallel to the transverse axis; wherein the first travelling roller and the heating device are with respect to a longitudinal center of the chassis arranged on opposite sides of the chassis. Further a corresponding method is provided.

### CROSS-REFERENCE TO RELATED APPLICATIONS

This application claims the priority of European patent application No. 23 150 789.8, filed Jan. 9, 2023, which is incorporated herein by reference in its entirety.

The present invention relates to an automatic welding machine for thermal joining material sheets/webs, and also relates to a corresponding method for thermal joining material sheets.

### BACKGROUND

Automatic welding machines for thermal joining material sheets are generally known from the state of the art. Such automatic welding machines are used, for example, for thermally joining or welding thermoplastic material sheets, such as plastic films or plastic or bitumen sheets, along their overlapping edge regions. In addition to a drive and at least one hot air unit or a heating wedge device, such automatic welding machines comprise a chassis comprising one or more travelling/drive rollers, pressure rollers and/or support rollers or a combination thereof. During the automatic welding process, the automatic welding machine moves over an essentially flat surface on which the materials to be welded are joined by the automatic welding machine. In case of hot air welding, at least one hot air nozzle, which is arranged at the hot air outlet of a hot air unit of the automatic welding machine, is guided into a welding region of the materials to be welded between the overlapping edge regions of the materials in order to plasticize the materials in the welding region by applying heat. Afterwards the plasticized regions of the materials are pressed together and a materially bonded connection is formed, for example by a pressure roller arranged downstream of the hot air nozzle in the working direction or direction of movement of the automatic welding machine.

DE 20 2018 101 429 U1 discloses an automatic welding machine for edge-side welding of planar, thermoplastic materials comprising a housing, at least one drive and at least one hot air unit for heating the materials to be welded in a welding region, wherein the hot air unit is arranged on the automatic welding machine such that the hot air unit can be rotated about an axis aligned parallel to the transverse axis of the housing and can be displaced along this axis.

To increase stability, in particular to prevent lateral tipping, ground-level hot-air welding machines often comprise additional support wheels that are spaced as far apart as possible. An example of an automatic welding machine is described in EP 3 028 836 B1. In certain applications close to an edge (parapets on roofs, etc.) these support wheels are sometimes in the way or prevent welding close to the edge. For this reason, the two lateral support wheels in EP 3 028 836 B1 are fixed together on a movable support and can thus be moved together to the one side or to the other of the automatic welding machine, depending on the welding task.

According to the summary, EP 3 028 836 B1 discloses an automatic welding machine for edge-side connection at the edge of sheets overlapping material sheets, wherein the materials are connectable to one another under the effect of heat and subsequent pressure, with a chassis on which at least guide rollers, a heating device and at least one pressure roller are arranged. The heating device has a cantilevered contact heating element that can be inserted laterally between the edges of the material sheets, wherein the chassis is driven by an electric motor which is arranged on a longitudinal leg of the chassis. The electric motor according to the invention is formed as a brushless DC motor and the reduction gear as a planetary gear, which are united by a drum drive motor. In this case, the DC motor is preferably a disk rotor motor.

The chassis in EP 3 028 836 B1 has a lateral or transverse leg which is adjustable perpendicular to the working direction relative to the longitudinal leg. The entire transverse leg with the non-driven guide rollers can thus be displaced laterally relative to the longitudinal leg, on which the heating device and the control unit of the automatic welding machine are arranged and to which the drum driving motor carrying the drive roller is fixed. The shape of the chassis can thus be changed, namely from a first L-shaped structural variant, wherein the lateral leg only protrudes in the working direction on the left side of the longitudinal leg, via T-shaped structural variants, wherein the lateral leg protrudes in the working direction to the left and right of the longitudinal leg, to a second L-shaped structural variant, wherein the lateral leg only protrudes in the working direction to the right of the longitudinal leg. This advantageously facilitates near-edge welding along upwards or downwards sloping surfaces supporting the material sheets, i.e. for example upwardly extending walls, doors, manholes or parapet edges and front edges of flat roofs.

### SUMMARY

Against this background, it is an object of the present disclosure to provide a further improved automatic welding machine for thermally joining material sheets. In particular, it would be desirable to provide an automatic welding machine with simple handling and/or to reduce a maintenance effort. Furthermore, it would be desirable to reduce manufacturing complexity in production.

According to a first aspect of the present disclosure, an automatic welding machine for thermally joining material sheets, in particular for edge-side joining of an overlapping upper material sheet to a lower material sheet, to be connected to one another in a materially bonded (substance-to-substance bonding) manner under the application of heat and subsequent application of pressure, is provided, comprising: a heating device for at least partially heating the material sheets to be joined in a connection area; a support frame with a housing; a pressure roller; at least two traveling rollers; wherein the pressure roller and the traveling rollers are arranged on the support frame and together with the support frame form a chassis, wherein the chassis comprises a longitudinal axis and a transverse axis perpendicular thereto, which span a chassis plane; wherein at least a first travelling roller of the two travelling rollers and/or the heating device is arranged to be movable by of a telescopic pull-out relative to the support frame in directions parallel to the transverse axis. The first travelling roller and the heating device can be arranged on opposite sides of the chassis with respect to a longitudinal center of the chassis.

According to a further aspect of the present disclosure, a method for thermally joining material sheets, in particular for edge-side joining of an overlapping upper material sheet to a lower material sheet, to be connected to one another in a materially bonded manner under the application of heat and subsequent application of pressure, is proposed, comprising the steps of: providing an automatic welding machine as described in the context of the present disclosure; transferring the heating device for at least partially heating the material sheets to be joined in a connection region from a rest position to a working position using the telescopic pull-out; and thermally joining the material sheets with the automatic welding machine.

Accordingly, in the automatic welding machine for thermally joining material sheets according to one aspect of the present invention, it is thus proposed to provide a telescopic pull-out which can be extended in a direction parallel to the transverse axis. The movement with the telescopic pull-out takes place by the elements of the telescopic pull-out being pushed into one another. The heating device can be fixedly arranged on the telescopic pull-out. Alternatively, a first travelling roller of the two travelling rollers can be arranged on the telescopic pull-out. A first telescopic pull-out for the heating device and a second telescopic pull-out for the first travelling roller can also be provided. By a telescopic pull-out, the first travelling roller of the two travelling rollers can be moved in a direction parallel to the transverse axis. Accordingly, the heating device can be moved in the direction parallel to the transverse axis by a telescopic pull-out. The telescopic pull-out is arranged and configured such that the first traveling roller or the heating device is displaced transversely to a longitudinal axis, i.e. transversely to a working direction or feed direction of the automatic welding machine during the thermal joining of material sheets. The telescopic pull-out can comprise a receptacle arranged fixedly on or in the support frame of the automatic welding machine, into which a shaft of the telescopic pull-out is (fully) inserted. Thereby, the shaft of the telescopic pull-out is protected by the receptacle when retracted. The use of a telescopic pull-out is advantageous in particular in an automatic welding machine for the thermal joining of material sheets, as maintenance work can be reduced. In the retracted state, the shaft of the telescopic pull-out can be protected from dirt. Furthermore, corrosion of exposed elements can be avoided. This can reduce the susceptibility to repair and increase the reliability of the automatic welding machine.

A further advantage of the proposed solution can be that, thanks to a telescopic pull-out projecting into the housing of the automatic welding machine, additional elements can be arranged inside the housing of the automatic welding machine in a protected manner. For example, a start-up switch for actuating a drive of the automatic welding machine can now be rearranged inside the housing. Thereby, this element can be better protected and its reliability further increased.

A further advantage of the proposed solution can be that simple, ergonomic retraction is enabled. Furthermore, handling can be improved in that by the telescopic pull-out any rigid axles protruding from the welding machine can be avoided. This can also increase work safety, as an operator cannot get caught on a protruding element.

In the context of the present disclosure, a telescopic pull-out can be understood to refer to a device which can be extended in the longitudinal direction with two or more coaxially arranged elements one inside the further. Each of the inner telescopic members can from the next largest member, which thus directly receives it, be axially extended. With other words, this is not merely a displacement of a rigid axis, but a sliding of elements into one another, wherein the extension in longitudinal direction is reduced in the retracted state.

According to an embodiment, the telescopic pull-out can comprise an axle (also referred to as a shaft in the context of the present disclosure), wherein the first traveling roller or the heating device is fixedly attached to the axle of the telescopic pull-out, wherein in an extended state the axle is pulled-out of the housing of the support frame and in a retracted state is received by the housing of the support frame, in particular is completely received or is completely inserted into the housing of the support frame. By the first traveling roller or the first heating direction being fixed to the axis of the telescopic pull-out, the movement thus takes place with the axis of the telescopic pull-out. It is to be understood that the fixed attachment can be released for example for maintenance purposes. The axle is in turn inserted into the housing of the support frame and preferably received by it completely. This protects the axle from soiling and can prevent corrosion. This can reduce the amount of maintenance required. In particular, when the heating device is operated in the retracted state, the susceptibility to repair can be reduced, as the axle is retracted in the housing in the working position, i.e. during the welding process, and is therefore less susceptible to corrosion and accumulation of dust.

The heating device can be arranged rotatably relative to the support frame about an axis parallel to the transverse axis, wherein the heating device can be fixed axially and rotationally relative to the support frame at least in a first axial and rotational pose and can be fixed at least axially relative to the support frame in a further, second axial and rotational pose which is at least axially different from the first pose. The axis can be an axle of the telescopic pull-out to which the heating device is fixed. The first pose can be a rest position of the heating device. In the rest position, the heating device can be fixed in a fixed rest position both in the axial direction and with regard to the rotation around the axis. The second pose can be a working position of the heating device. In the working position, the axle with the heating device is primarily axially fixed. However, a rotational movement, at least over a limited angular range, can still be allowed. Thereby, a working height of an outlet nozzle of the heating device can be adapted to a surface or flexibly different outlet nozzles of a heating device can be fixed. In the case of a heating wedge device, different heating wedges can be flexibly employed.

In an embodiment, the heating device can be arranged on the support frame by the telescopic pull-out. The telescopic pull-out can comprise a receptacle fixed to the support frame and a shaft. The shaft can extend between a first axial shaft end and a second axial shaft end along a shaft axis parallel to the transverse axis, wherein the second axial shaft end is the axial shaft end facing away from the housing. The shaft can be movable along the shaft axis and mounted at the receptacle (stored by a storing/bearing) so that it can rotate about the shaft axis. The heating device can be arranged on the shaft in a region of the second axial shaft end.

For fixing the heating device in the first pose and/or in the second pose, the shaft can be releasably fixed to the receptacle by a locking device of the receptacle device. The locking device can comprise at least one locking bolt, wherein the locking bolt is oriented in a direction of a locking axis perpendicularly intersecting the shaft axis and is movable in the direction of the locking axis, and wherein the shaft can be fixed at least in the first pose and/or in the second pose by at least partial engagement of the locking bolt radially to the shaft axis into the shaft. Hereby, the locking bolt can be loaded by a spring force in the direction of the shaft axis. In order to enable a limited rotational movement in a working position in the second pose, the shaft can comprise a longitudinal hole for engagement of the locking bolt.

A handle lever can be arranged at the second axial end of the shaft. The handle lever and the telescopic pull-out can be configured to provide manual rotation of the shaft about the shaft axis. The handle lever and the telescopic pull-out can be configured to provide manual displacement of the shaft in directions along the shaft axis. The handle lever and the telescopic pull-out can be configured to provide a manual release of a fixation of the shaft from the receptacle.

In a further refinement, a coaxial stud can be received in an interior of the shaft of the telescopic pull-out, wherein the coaxial stud extends parallel to the shaft axis at least partially through the shaft, wherein the coaxial stud is movable in directions parallel to the shaft axis, wherein the locking bolt can be at least partially brought (into contact and/or) into engagement with the coaxial stud at least in the first pose and/or the second pose, and wherein the locking bolt can be disengagement from the coaxial stud by a movement of the coaxial stud in a direction along the shaft axis relative to the shaft. In particular, the coaxial stud can be configured such that the locking bolt can be disengaged from the coaxial stud by a longitudinal movement of the coaxial stud in a direction along the shaft axis. In other words, a locking of the shaft axis by the locking bolt can be released by the longitudinal movement of the coaxial stud within the shaft axis. Hereby, the locking bolt can be actuated in a simple manner. By actuating the locking bolt in such a defined manner, mechanical stress can preferably be reduced and, for example, breakage of the locking bolt can be prevented. A further advantage can thus be an improved reliability.

The coaxial stud can project with an axial end beyond the second shaft end out of the shaft, wherein the handle lever is arranged at this axial end of the coaxial stud, wherein a spring element is clamped between the handle lever and the second shaft end, wherein a movement of the coaxial stud along the shaft axis in the direction of the second shaft end is limited by a stop inside the shaft in combination with a counter-stop of the coaxial stud. An axial end of the coaxial stud can be an extension of the coaxial stud associated with the coaxial stud. In other words, the coaxial stud is not necessarily configured in one piece. Optionally, the handle lever can be configured to be inclined relative to a plane with a normal parallel to the shaft axis at an acute angle to the plane. An advantage of this embodiment can be that the heating device (together with the shaft) can be moved very easily and ergonomically by the handle lever at the axial end. Further, this handle can also serve to release the locking mechanism at the same time. The heating device can thus preferably be swung in and out with one hand.

The automatic welding machine can comprise a drive (also referred to as drive device or drive unit). The drive can be coupled with a start-up switch, which is configured to provide a release (enable) signal for the drive, wherein the start-up switch is arranged in the interior of the housing and is configured to be actuated by retraction of the telescopic pull-out into the interior of the housing, in particular by a retracting shaft of the telescopic pull-out. An advantage of this embodiment can be that the switch is located in the housing and is therefore well protected from external influences. For example, the shaft of the telescopic pull-out can actuate an electro-mechanical switch in the housing when retracted, which transmits a signal to a control system with which the drive (feed of the automatic welding machine) can be switched on or off. Optionally, a delay can be provided so that the user can switch from a handle with which the telescopic pull-out is operated to a guide rod for guiding the automatic welding machine.

Alternatively or additionally, the first travelling roller (guide roller or caster) can be arranged on the support frame by the telescopic pull-out. Hereby, the telescopic pull-out for the travelling roller can comprise a dovetail rail or guide. This can be a second telescopic pull-out for the first travelling roller. The heating device can be arranged on the automatic welding machine via a separate first telescopic pull-out so that it can be adjusted in the transversal direction. By arranging the first travel roller on the support frame by the telescopic pull-out, the track width can be adjusted. However, not one axle with both travelling rollers is moved. The second travelling roller on the opposite side in the transversal direction can be firmly attached to the frame and cannot be moved. Preferably, the first travelling roller can disappear completely into the frame when retracted so that nothing protrudes to the side. This can enable welding close to the edge. An advantage of the embodiment of the telescopic pull-out for the travelling roller as a dovetail rail can be that the telescopic pull-out can even when subjected to a transverse load transverse to the direction of extension be supported in a particularly smooth-running manner and at the same time can offer minimal play or slack, which in turn favors stability and guiding accuracy.

In a further refinement, the telescopic pull-out with the first travelling roller can at least be configured not to protrude beyond the support frame in a direction parallel to the transverse axis at a minimum distance of the travelling roller from the longitudinal center of the support frame. The telescopic pull-out with the first roller can be configured to terminate flush with the support frame with an axial cantilever end facing away from the longitudinal center. This can enable welding processes that are particularly close to the edge.

The automatic welding machine can further comprise an adjustment device for adjusting the alignment of at least one of the rollers. An advantage of this embodiment can be that directional stability can be improved. For example, an adjusting screw can be provided at a second travelling roller, which is opposite the telescopic pull-out with the first travelling roller parallel to the transverse axis of the chassis, with which the track or the directional stability of the automatic welding machine can be adjusted.

The advantages described in detail above for the first aspect of the invention apply accordingly to the further aspects of the invention.

It is to be understood that the features mentioned above and those yet to be explained below may be used not only in the combination respectively indicated, but also in other combinations or separately, without departing from the scope of the present invention.

### BRIEF DESCRIPTION OF THE DRAWINGS

Exemplary embodiments of aspects of the invention are illustrated in the following drawings and are explained in more detail in the following description.

FIG. 1 shows a perspective schematic illustration of a ground-level automatic welding machine in a working position;

FIG. 2 shows a further perspective schematic illustration of the ground-level automatic welding machine of FIG. 1 in a rest position;

FIG. 3 shows a front view of the automatic welding machine of FIG. 1 in the working position;

FIG. 4 shows a front view of the automatic welding machine of FIG. 2 in the rest position;

FIG. 5 shows a perspective schematic illustration of a telescopic pull-out for a heating device for an automatic welding machine in a retracted state,

FIG. 6 shows a perspective schematic illustration of the telescopic pull-out of FIG. 5 in an extended state,

FIG. 7 shows a side view of the telescopic pull-out of FIG. 5. in the retracted state and actuation of a start-up switch with the start-up switch closed;

FIG. 8 shows a side view of the telescopic pull-out of FIG. 5 in the extended state with the start switch open;

FIG. 9 shows a sectional view of the telescopic pull-out of FIG. 7 along axis IX-IX;

FIG. 10 shows a sectional view of the telescopic pull-out of FIG. 7 along axis X-X;

FIG. 11 shows a perspective illustration of an automatic welding machine with a telescopic pull-out for a traveling roller;

FIG. 12 shows a perspective illustration of a section of the automatic welding machine with traveling roller in an extended state;

FIG. 13 shows a perspective illustration of a section of the automatic welding machine with roller in a retracted state;

FIG. 14 shows a further perspective illustration of a section of the automatic welding machine with travelling roller in an extended state of FIG. 12;

FIG. 15 shows a further perspective illustration of a section of the automatic welding machine with travelling roller in a retracted state of FIG. 14;

FIG. 16 shows a side view of a telescopic pull-out for a travelling roller with a dovetail rail;

FIG. 17 shows a front view of a section of the automatic welding machine with travelling roller in an extended state;

FIG. 18 shows a front view of a section of the automatic welding machine with travelling roller in a retracted state;

FIG. 19 shows a perspective view of a second fixed travelling roller with adjusting device for adjusting an alignment; and

FIG. 20 shows a flow chart of a method for thermally joining material sheets.

### DETAILED DESCRIPTION

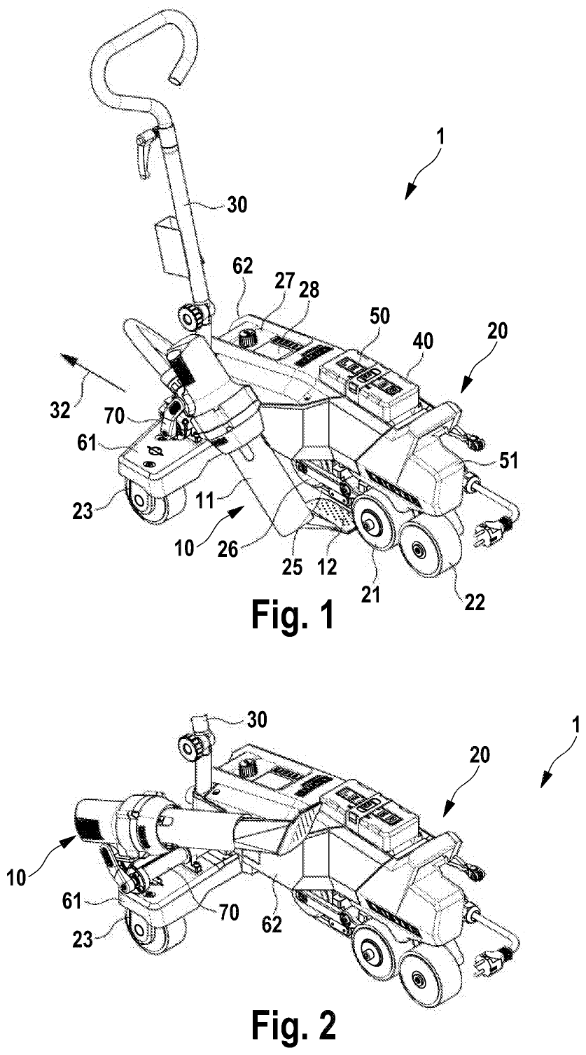

FIG. 1 and FIG. 2 show perspective schematic illustrations of an exemplary automatic welding machine 1 for thermally joining material sheets. The automatic welding machine 1 is configured for edge-side joining of an overlapping upper material sheet with a lower material sheet, which can be connected to one another in a materially bonded manner under the application of heat and subsequent application of pressure. The automatic welding machine 1 comprises a heating device 10 and a chassis 20 with a guide rod 30 for guiding the automatic welding machine.

The heating device 10 is configured to at least partially heat the material sheets to be joined in a connection region. In the embodiment shown, the heating device 10 is configured as a hot air blower with a blower body 11 with an internal heating element and a fan for generating an air volume flow and a hot air nozzle 12. In FIG. 1, the heating device 10 is in a working position. In FIG. 2, on the other hand, the heating device is in a rest position, preferably extended sideways and tilted upwardly. In the working position, the hot air nozzle is inserted in an overlap region between an upper material sheet and a lower material sheet (not illustrated). Thereby the heating device can heat a bottom side of the upper material sheet and a top side of the lower material sheet and, in particular, at least partially plasticize or melt them. Alternatively, the heating device 10 can be configured as a heating wedge device with an electrically heated heating wedge.

In particular for sealing or waterproofing a roof, the material sheets, such as sealing or waterproofing membranes, are welded in their overlapping region with so-called ground-level hot air automatic welding machines. Therein a hot air nozzle attached to a hot air blower slides between the overlapping sheets of material. This nozzle or the entire hot air blower should be inserted into or retracted from the overlap at the start or end of the welding respectively. For this a so-called insertion arrangement can be provided, which moves the hot air blower back and forth between a rest position (FIG. 2) and a working position (FIG. 1) in a controlled manner. The hot air blower is usually moved laterally (axially) along a transverse axis and simultaneously rotated about an axis (rotationally) for this.

A working direction of the automatic welding machine 1 is illustrated in FIG. 1 with an arrow and designated with reference sign 32. The working direction hereby denotes a forward direction in which the automatic welding machine 1 is guided along the overlapping material sheets during operation for edge-side joining. The chassis 20 comprises a pressure roller 21, which is configured to apply pressure to the material sheets in the working direction behind the heating device 10. The pressure roller 21 can at the same time also be configured as a drive roller that automatically drives the automatic welding machine 1. In the shown embodiment, however, an optional separate drive roller 22 is provided. In the embodiment shown, the chassis further comprises a first guide or travelling roller 23 and a second guide or travelling roller 24. The travelling rollers are arranged at the front in the working direction 32. The first travelling roller 23 can therefore be referred to as the left travelling roller, and the second travelling roller 24 can be referred to as the right travelling roller.

In order to further improve the air flow or the heat input between the overlapping material sheets, a pressure belt 25 can optionally be provided. The pressure belt 25 extends, for pressing the edge of an overlapping upper material sheet not shown in the figure against an overlapping lower material sheet, which is also not shown, from between the pressure roller 21 to a preferably tensionable belt guide pulley 26, which is arranged adjacent to or in front of the hot air nozzle in the working direction. The pressure belt 25 can be configured to press the overlapping edge (or rim) of the upper material sheet against the lower material sheet, thus preventing the hot air flow from the hot air nozzle 12 from penetrating under the overlapping upper material sheet. By sealing the overlapping edge at the side, power loss can be reduced and the hot air flow can be guided in the direction against the working direction of the automatic welding machine 1.

As shown in the embodiment illustrated in FIG. 1 and FIG. 2, the automatic welding machine 1 can further comprise a controller 27 (also referred to as control unit) and a display unit 28. In the present embodiment, the controller 27 and the display unit 28 are arranged on a top side of the automatic welding machine. However, it is to be understood that the controller 27 and/or display unit 28 can also be implemented as wireless units which are connected to the automatic welding machine via a communication interface. For example, a smartphone or tablet with corresponding software can be used as a display unit 28 or as an operating interface for a controller.

The automatic welding machine 1 can further comprise a mount 40 for one or more additional weights 50, which are configured to increase a pressure on the pressure roller 21. FIG. 1 shows a perspective view of the automatic welding machine 1 with one additional weight 50. Furthermore, the automatic welding machine 1 can also comprise a permanently installed weight 51, by which a minimum contact pressure without additional weights is defined.

As shown in FIG. 1 to FIG. 3, the chassis 20 is formed by a support frame 61 with a housing 62 as well as by the pressure roller 21 and the two travelling rollers 23, 24. The chassis comprises a longitudinal axis parallel to the working direction 32 and a transverse axis perpendicular thereto, which span a chassis plane. At least one travelling roller 24 of the two travelling rollers 23, 24 and/or the heating device 10 can be arranged movably by a telescopic pull-out 70 relative to the support frame 61 with the housing 62. In other words, the heating device 61 and/or the travelling roller 24 can be extended transversely to the drive direction 32 with a telescopic pull-out.

In the embodiment described with reference to FIG. 1 to FIG. 10, the heating device 10 is arranged movable by the telescopic pull-out 70 in the transversal direction on the support frame 61 with the housing 62.

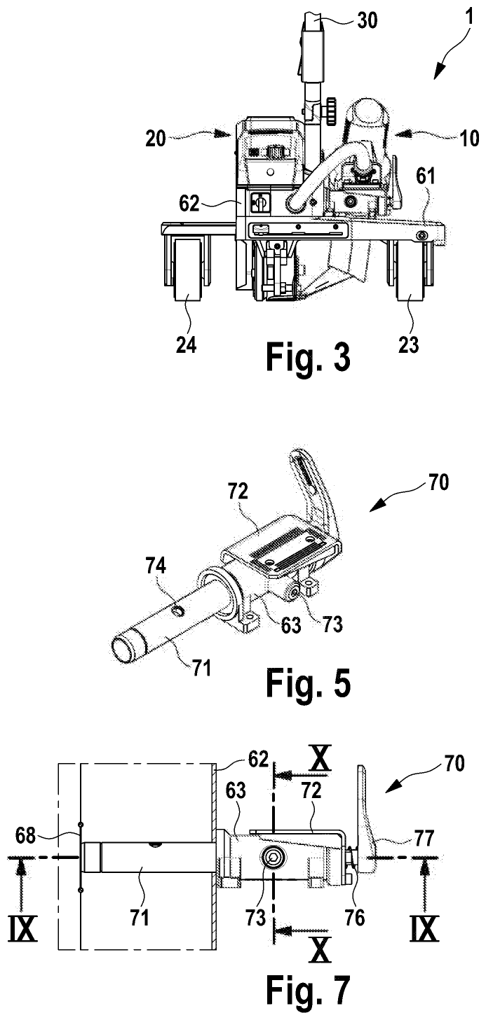

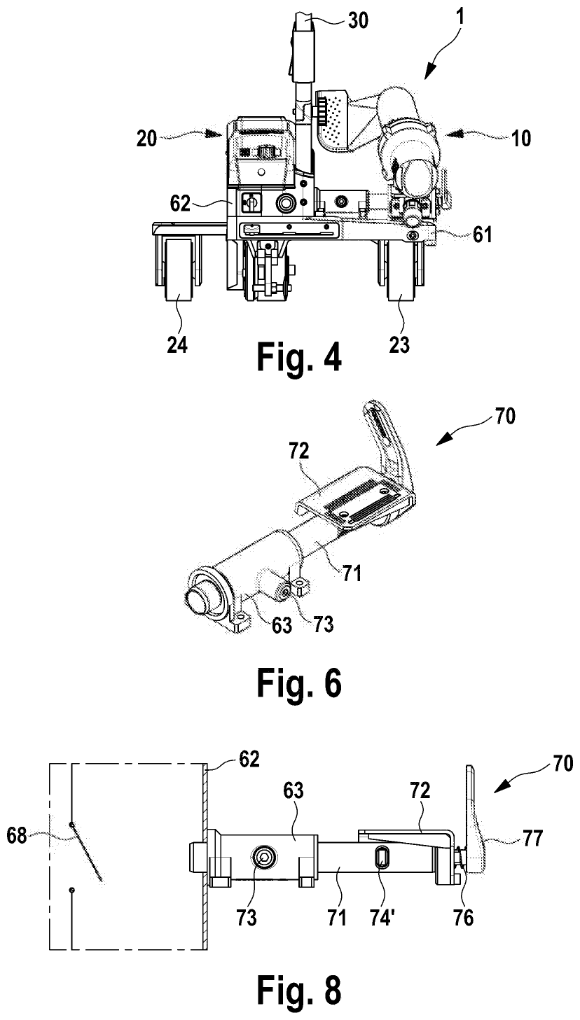

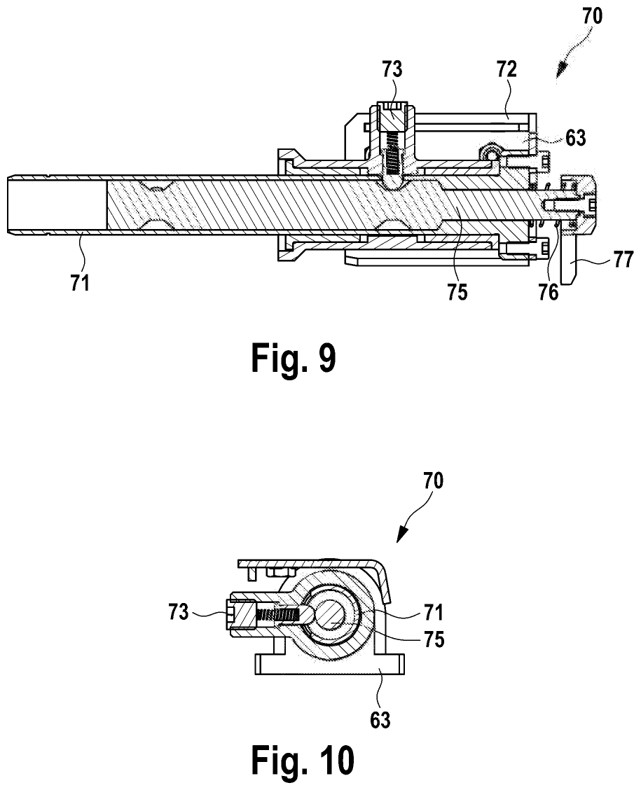

The odd FIG. 1, FIG. 3, FIG. 5, FIG. 7 as well as FIG. 9 and FIG. 10 hereby show the automatic welding machine or parts thereof with the telescopic pull-out in a retracted state in a working position. On the other hand, the even FIG. 2, FIG. 4, FIG. 6 and FIG. 8 show the automatic welding machine or parts thereof with the telescopic pull-out in an extended state in a rest position. FIG. 3 and FIG. 4 show a front view of the automatic welding machine 1 in a working position with the telescopic pull-out 70 for the heating device 10 retracted (FIG. 3) versus a front view of the automatic welding machine 1 in a rest position with the telescopic pull-out 70 for the heating device 10 extended (FIG. 4). FIG. 5 and FIG. 6 illustrate a perspective schematic illustration of a telescopic pull-out for a heating device for an automatic welding machine in a retracted state (FIG. 5) and in an extended state (FIG. 6). Accordingly, FIG. 7 shows a side view of the telescopic pull-out 70 of FIG. 5. in a state retracted into the housing 62 and FIG. 8 shows a side view of the telescopic pull-out of FIG. 6 in a state extended out of the housing 62.

The telescopic pull-out 70 comprises an axle 71, wherein the heating device 10 is fixedly attached to the axle 71 of the telescopic pull-out 70. In the embodiment shown, a mounting plate 72 is arranged on the axle 71. The heating device 10 can, for example using a screw connection be fixed firmly but detachably to the connecting plate 72. The housing 62 can comprise a receptacle fixedly attached on or in the housing. The receptacle 63 is at the same time part of the telescopic pull-out and serves, together with the furthermore receptacle 62, for receiving the telescopic pull-out in the retracted state, as shown, for example, in FIG. 3 and FIG. 7.

The axle 71 can be mounted slidably and rotatably in the fixed receptacle housing (bearing) 63. In order to move the heating device 10 back and forth in a controlled manner between the rest position (FIG. 2, FIG. 4) and the working position (FIG. 1, FIG. 3), the heating device 10 is moved axially along the axis 71 and simultaneously rotated about the axis. In the rest position (FIG. 2, FIG. 4), the axis 71 of the telescopic pull-out 70 can be locked both axially and rotationally. In the embodiment shown, for this purpose a radial, spring-loaded locking bolt 73 attached to the receptacle 63 is provided, which can engage in a hole or bore 74, 74′ provided on the axle 71. In a further refinement, the locking can be released by a, preferably spring-loaded long bolt 75, which is embedded axially in the axle and presses the locking bolt 73 out of the bore 74, 74′, as illustrated in FIG. 9 and FIG. 10. The long bolt 75 is also referred to as a coaxial stud, since it is arranged coaxially in the axle 71.

In the rest position (see FIG. 2, FIG. 4) as a first axial and rotational pose relative to the support frame, the heating device can be fixed both axially and rotationally with the proposed telescopic pull-out. Hereby, as shown in FIG. 5, a bore 74 can be provided in the axle 71, the size of which is adapted in a longitudinal and transversal direction to a size of the locking bolt 73. The axle is thus fixed both axially and rotationally. In contrast, in the working position (see FIG. 1, FIG. 3), it is desirable that the heating device 10 is locked axially by the telescopic pull-out, but allows a rotational movement over a certain angular range. As for example shown in FIG. 8, the hole 74′ can therefore be configured as an elongated hole instead of a (round) hole. The release of the locking mechanism can be effected with the same long bolt or coaxial stud 75, wherein, however, a different recess is used. As shown in FIG. 9 and FIG. 10, the locking bolt 73 is guided through the bore 74′ into a recess in the coaxial stud. When the coaxial stud is pressed in the axial direction of the axis 71 in the direction of the housing 62 (see, for example, FIG. 8), the locking bolt 73 can for example, by a sloped side wall of a recess in the coaxial stud be pressed radially outwards. The locking mechanism can thus be disengaged in a simple way.

As shown in FIG. 9, a handle 77 is provided at an outward-facing end of the axle 71 with the coaxial stud 75. The automatic welding machine is configured such that, on the one hand, the heating device 10 can be moved together with the axis 71 of the telescopic pull-out 70 using the handle 77. In addition, the handle 77 serves to release the locking mechanism, as the handle 77 is coupled to the coaxial stud 75. The handle 77 with the coaxial stud 75 can be supported against the axle 71 by a spring 76. When the handle 77 is not actuated, the spring 76 causes the coaxial stud to be positioned such that the locking bolts dives into the recesses of the coaxial stud 75 and secure locking is enabled.

The automatic welding machine preferably comprises a drive for automatic propulsion. It would be desirable if it can be ensured in the rest position that the automatic welding machine does not start moving automatically or is not actuated accidentally. The drive can therefore be coupled with a start-up switch, which is configured to provide an enable or release signal for the drive. This can be a control signal. Alternatively, by the start-up switch a power supply to the drive can be established or interrupted. FIGS. 7 and 8 show an advantageous schematic arrangement of a start-up switch 68, wherein the start-up switch is arranged in the interior of the housing 62. This protects the start-up switch and can reduce the risk of a malfunction. In the rest position, as shown in FIG. 4 and FIG. 8, the start-up switch is open. In the working position, as shown in FIGS. 3 and 7, the start-up switch is closed. Thereby, the start-up switch in the shown embodiment is actuated by the retracted axle 71 of the telescopic pull-out 70. In the retracted state, the axle in the housing can for example actuate an electromechanical switch, which transmits a signal to the control unit with which the drive (feed) of the automatic welding machine can be switched on or off. Optionally, a delay can be provided so that the operator can reach over to the guide rod.

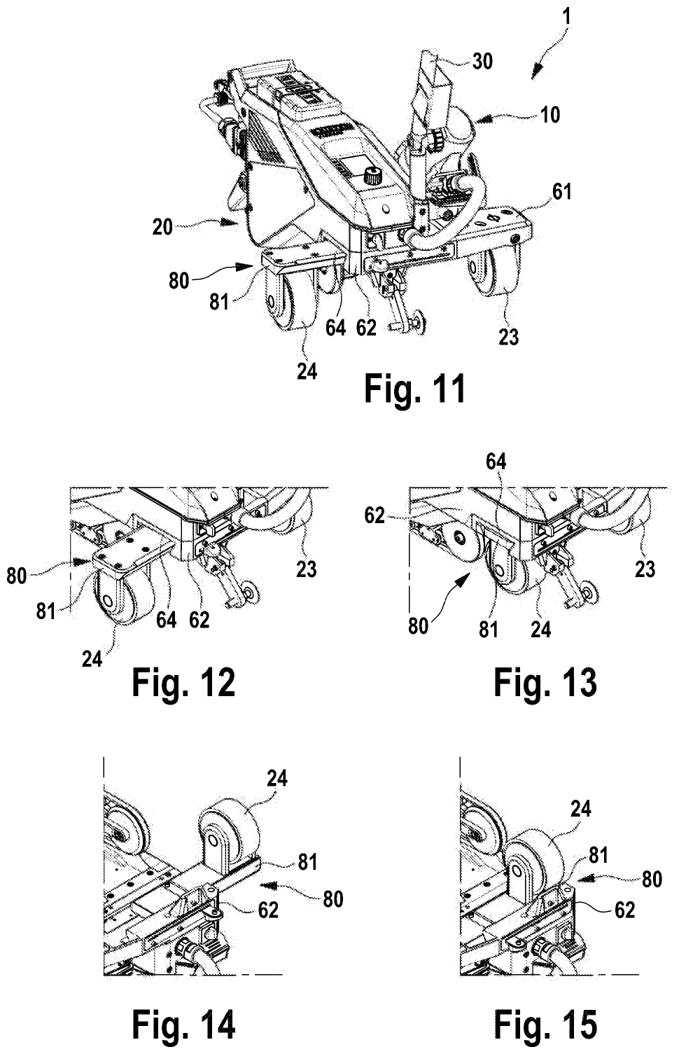

In the embodiment described with reference to FIG. 11 to FIG. 18, the travelling roller 24 is arranged movable by the telescopic pull-out 80 in the transversal direction on the support frame 61 with the housing 62. Optionally, both a first telescopic pull-out 70 for the heating device 10 and a second telescopic pull-out 80 for the travelling roller 24 can be provided. Hereby, FIG. 11, FIG. 12, FIG. 14 and FIG. 17 show the telescopic pull-out 80 in an extended state. FIG. 13, FIG. 15 and FIG. 18 show the telescopic pull-out 80 in a retracted state. An advantage of this embodiment can be that, if necessary, the support with the travelling roller can be fully retracted into the housing of the automatic welding machine by the telescopic pull-out 80 if necessary, for example for transportation or in narrow working conditions. In an extended state, on the other hand, a high level of stability and good straight-ahead driving properties can be provided.

The telescopic pull-out 80 comprises an axle 81, wherein the traveling roller 24 is arranged in the transversal direction at an outer end of the axle 81. The housing 62 can comprise a receptacle 64 arranged fixedly on or in the housing. The receptacle 64 is at the same time part of the telescopic pull-out and serves, together with the further housing 62, for the receptacle of the telescopic pull-out in the retracted state, as shown, for example, in FIG. 13. The other travelling roller 23 is fixedly attached to the chassis (in the transversal direction on the opposite side), in particular to a support frame 61 of the chassis. The fixedly attached travelling roller 23 can further improve the stability and directional alignment of the automatic welding machine, since no movable or displaceable elements are required.

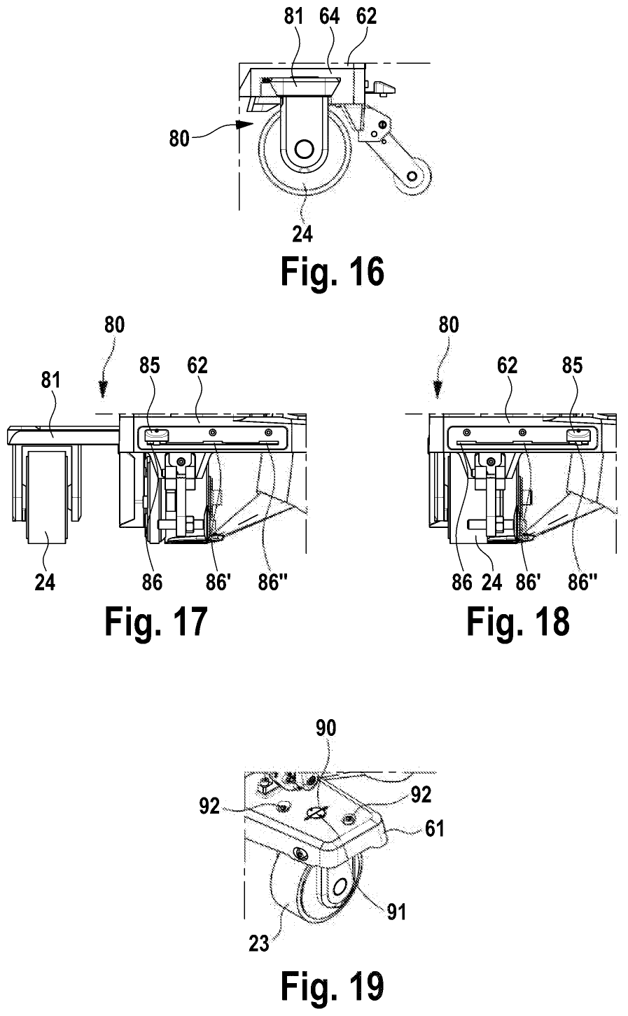

As shown in FIG. 16, the telescopic pull-out 80 for the travelling roller 24 can comprise a dovetail rail. An advantage of the implementation of the telescopic pull-out for the travelling roller as a dovetail rail can be that the telescopic pull-out can be received in a particularly smooth-running manner even when subjected to a transverse load transverse to the direction of extension and at the same time can provide minimal play or slack, which in turn favors stability and guiding accuracy.

As shown in FIG. 17 and FIG. 18, the telescopic pull-out 80 can optionally comprise an actuating lever 85, with which various positions 86, 86′, 86″ can be set in longitudinal direction of the telescopic pull-out 80. For example, a plate can be mounted on the axle 81 which, depending on the lateral position, can engage in associated recesses on the housing 62. This allows predefined lateral positions (in this case three) to be set with repeatable precision.

FIG. 19 shows a perspective view of a second fixed travelling roller 23 with an adjustment device 90 for adjusting the alignment. The adjustment device 90 can comprise an indicator 91 which indicates an orientation of the travelling roller 23. The alignment or track of the travelling roller can be adjusted, for example, by one or more adjusting screws 92.

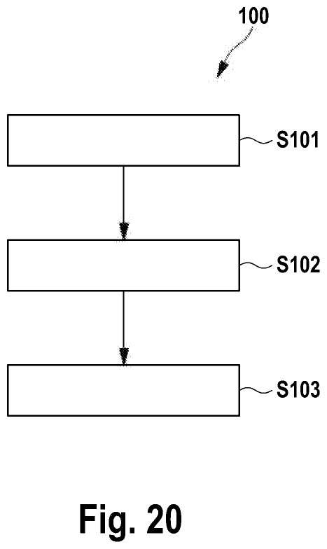

FIG. 20 shows a flowchart 100 of a method for thermally joining material sheets, in particular for edge-side joining of an overlapping upper material sheet with a lower material sheet, which can be connected to one another in a materially bonded manner under the application of heat and subsequent application of pressure. In a first step S101, an automatic welding machine as described in the context of the present disclosure is provided. In a second step S102, the heating device 19 is transferred from a rest position to a working position using the telescopic pull-out for at least partially heating the material sheets to be joined in a connection region. In a third step S102, the material sheets are thermally joined with the automatic welding machine.

In summary, with the solutions provided herein an improved automatic welding machine for the thermal joining of material sheets can be provided, in particular for edge-side joining of an overlapping upper material sheet with a lower material sheet, which can be connected to one another in a materially bonded manner under the application of heat and subsequent application of pressure. The proposed solution allows the provision of an automatic welding machine with easy handling and/or reduced maintenance requirements. Compared to fully automatic lowering and swivel-in devices, the manufacturing complexity can be reduced.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above.

Various other embodiments and various changes and modifications to the disclosed embodiment(s) will become apparent to those skilled in the art. As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

What is claimed is:

1. An automatic welding machine for thermal joining of material sheets, in particular for edge-side joining of an overlapping upper material sheet to a lower material sheet, to be connected to one another in a materially bonded manner under the application of heat and subsequent application of pressure, comprising
a heating device for at least partially heating the material sheets to be joined in a connection region,
a support frame with a housing,
a pressure roller,
at least two travelling rollers,
wherein the pressure roller and the traveling rollers are arranged on the support frame and together with the support frame form a chassis, wherein the chassis comprises a longitudinal axis and a transverse axis perpendicular thereto, which span a chassis plane,
wherein at least a first travelling roller of the two travelling rollers and/or the heating device is arranged to be movable by a telescopic pull-out relative to the support frame in directions parallel to the transverse axis,
wherein the first travelling roller and the heating device are with respect to a longitudinal center of the chassis arranged on opposite sides of the chassis.

2. The automatic welding machine according to claim 1, wherein the telescopic pull-out comprises an axle, wherein the first traveling roller or the heating device is fixedly attached to the axle of the telescopic pull-out, wherein in an extended state the axle is pulled-out of the housing of the support frame and in a retracted state is received by the housing of the support frame.

3. The automatic welding machine according to claim 1, wherein the heating device is arranged rotatably relative to the support frame about an axis parallel to the transverse axis, wherein the heating device is fixable axially and rotationally relative to the support frame at least in a first axial and rotational pose and is fixable at least axially relative to the support frame in a further, second axial and rotational pose which is at least axially different from the first pose.

4. The automatic welding machine according to claim 3, wherein the heating device is arranged on the support frame by the telescopic pull-out,
wherein the telescopic pull-out comprises a receptacle fixed to the support frame and a shaft,
wherein the shaft extends between a first axial shaft end and a second axial shaft end along a shaft axis parallel to the transverse axis,
wherein the second axial shaft end is the axial shaft end facing away from the housing,
wherein the shaft is mounted at the receptacle so as to be movable along the shaft axis and rotatable about the shaft axis, and
wherein the heating device is arranged on the shaft in a region of the second axial shaft end.

5. The automatic welding machine according to claim 4, wherein for fixing the heating device in the first pose and/or in the second pose the shaft can be releasably fixed to the receptacle by a locking device of the receptacle.

6. The automatic welding machine according to claim 5, wherein the locking device comprises at least one locking bolt,
wherein the locking bolt is oriented in a direction of a locking axis perpendicularly intersecting the shaft axis and is movable in the direction of the locking axis, and
wherein the shaft can be fixed at least in the first pose and/or in the second pose by an at least partial engagement of the locking bolt radially to the shaft axis into the shaft.

7. The automatic welding machine according to claim 6, wherein the locking bolt is loaded by a spring force in direction of the shaft axis.

8. The automatic welding machine according to claim 3, wherein a handle lever is arranged at the second axial shaft end, which is configured to provide a manual rotation of the shaft about the shaft axis, a manual displacement of the shaft in directions along the shaft axis and/or a manual release of a fixation of the shaft from the receptacle.

9. The automatic welding machine according to claim 8, wherein a coaxial stud is received in an interior of the shaft of the telescopic pull-out,
wherein the coaxial stud extends parallel to the shaft axis at least partially through the shaft,
wherein the coaxial stud is movable in directions to the shaft axis,
wherein the locking bolt can be at least partially brought into engagement with the coaxial stud at least in the first pose and/or the second pose, and
wherein the locking bolt can be disengaged from the coaxial stud by a movement of the coaxial stud in a direction along the shaft axis relative to the shaft.

10. The automatic welding machine according to claim 9, wherein the coaxial stud projects with an axial end beyond the second end of the shaft out of the shaft,
wherein the handle lever is arranged at this axial end of the coaxial stud, wherein a spring element is clamped between the handle lever and the second shaft end,
wherein a movement of the coaxial stud along the shaft axis in the direction of the second shaft end is limited by a stop inside the shaft in combination with a counter-stop of the coaxial stud.

11. The automatic welding machine according to claim 1,
wherein the automatic welding machine comprises a drive,
wherein the drive is coupled with a start-up switch which is configured to provide an release signal for the drive, wherein the start-up switch is arranged in the interior of the housing and is configured to be actuated by retraction of the telescopic pull-out into the interior of the housing.

12. The automatic welding machine according to claim 11, wherein the start-up switch is configured to be actuated by a retracting shaft of the telescopic pull-out.

13. The automatic welding machine according to claim 1, wherein the first traveling roller is arranged on the support frame by the telescopic pull-out, wherein the telescopic pull-out for the traveling roller comprises a dovetail rail.

14. The automatic welding machine according to claim 13, wherein the telescopic pull-out with the first traveling roller is configured not to protrude beyond the support frame at least at a minimum distance of the traveling roller from the longitudinal center of the support frame parallel to the transverse axis in a direction parallel to the transverse axis.

15. The automatic welding machine according to claim 14, wherein the telescopic pull-out with the first traveling roller terminates flush with the support frame with an axial cantilever end facing away from the longitudinal center.

16. The automatic welding machine according to claim 1, further comprising an adjusting device for adjusting the alignment of at least one of the traveling rollers.

17. A method for thermal joining of material sheets, in particular for edge-side joining of an overlapping upper material sheet to a lower material sheet, to be joined together in a materially bonded manner under the application of heat and subsequent application of pressure, comprising the steps of
providing an automatic welding machine according to claim 1;
transferring the heating device for at least partially heating the material sheets to be joined in a connection region from a rest position to a working position using the telescopic pull-out; and
thermal joining of the material sheets with the automatic welding machine.
